(19) United States
(12) Patent Application Publication
(10) Pub. No.: US 2025/0147808 A1
(43) Pub. Date: May 8, 2025

(54) RESOURCE OPTIMIZATION METHOD AND DEVICE THROUGH DYNAMIC SPINLOCK

(71) Applicant: Hyundai AutoEver Corp., Seoul (KR)

(72) Inventors: Jun Ho CHO, Seoul (KR); Ki Young YOON, Seoul (KR)

(21) Appl. No.: 18/932,900

(22) Filed: Oct. 31, 2024

(30) Foreign Application Priority Data
Nov. 8, 2023 (KR) 10-2023-0153275

(51) Int. Cl. G06F 9/50

(52) U.S. Cl. CPC G06F 9/5027

(57) ABSTRACT

Described herein are resource optimization methods and devices using a dynamic spinlock. According to one embodiment, a method includes generating a plurality of spinlock resources depending on data sharers, measuring a spinlock time for each spinlock resource among the plurality of spinlock resources, and integrating at least two spinlock resources of the plurality of spinlock resources with short spinlock times.

### CROSS REFERENCE TO RELATED APPLICATION

This application claims the benefit of and priority to Korea Patent Application No. 10-2023-0153275, filed on Nov. 8, 2023, the entire disclosure of which is hereby incorporated herein by reference in its entirety.

### FIELD OF TECHNOLOGY

The present disclosure relates to a technique for optimizing a resource.

### BACKGROUND

An Automotive Open System Architecture (AUTOSAR) supports an operation on a multi-core system. In particular, using the AUTOSAR OS that supports a multi-core microcontroller enables communication and data exchange between cores.

The AUTOSAR provides a mechanism such as an Inter-Core Communication Interface (ICI) or various services, thereby supporting communication between the cores. The ICI is used to transmit data between software components running on different cores.

Further, the AUTOSAR OS supports concurrency control and communication in multi-core environment through functions such as spinlocks.

In vehicle software using the AUTOSAR OS, communication between the cores occurs frequently. To this end, the spinlock may be used to prevent a third core from accessing the corresponding data.

If the spinlock is applied to the data, the third core will wait until the spinlock is released. However, if the waiting time becomes long, it may affect the real-time performance of the system, thereby causing problems.

Generally, only one spinlock is used for data communication between multiple cores, which causes many problems in an autonomous driving controller where there is a lot of data communication between cores. For example, due to communication between a first core and a second core, the third core experiences frequent waiting times, thereby causing a problem where the system fails to maintain real-time performance.

The discussions in this section are intended merely to provide background information and do not constitute an admission of prior art.

### SUMMARY

In an aspect, an objective of this embodiment is to provide a technique for minimizing waiting time due to communication between cores in a multi-core system. In another aspect, this embodiment is to provide a technique for optimizing a resource through a dynamic spinlock.

In order to accomplish the above objectives, the present disclosure provides a resource optimization method through a dynamic spinlock, the method including generating spinlock resources depending on data sharers, measuring spinlock time for each spinlock resource, and integrating at least two spinlock resources with short spinlock times.

In generating the spinlock resources, the spinlock resources may be generated for all cases of the data sharers.

One bit may be allocated for each of the data sharers, and an identifier for each spinlock resource may be generated using a value of a corresponding bit.

In integrating the spinlock resources, identifiers of spinlock resources to be integrated may be made to be identical.

The identifier may be stored in a Random Access Memory (RAM).

In integrating the spinlock resources, at least two spinlock resources having short spinlock times are continuously integrated until a sum of the first shortest time and the second shortest time for the spinlock time becomes longer than the longest time.

The sharers may operate on different cores.

The present disclosure provides a resource optimization device through a dynamic spinlock, the device including a plurality of applications running on different cores, and a Runtime Environment (RTE) supporting data sharing between the applications, and the RTE generates spinlock resources depending on data sharing cases of the applications, measures spinlock time for each spinlock resource, and then integrates at least two spinlock resources with short spinlock times.

The spinlock resources may be stored and managed in a RAM.

The RTE may manage data sharing between the applications as pair information, and the pair information may be expressed as a bit value.

The data sharing case may include 1:1 sharing and 1:N (N is a natural number of 2 or more) sharing.

The RTE may run on an Automotive Open System Architecture (AUTOSAR) OS.

The RTE may independently allocate each spinlock resource depending on the data sharing case.

The spinlock time may be measured at runtime.

The RTE may allocate one bit for each of the applications, and generate an identifier for each spinlock resource based on a value of a corresponding bit.

The RTE may make identifiers for spinlock resources to be integrated identically.

The identifier may be stored in a RAM variable.

The present disclosure provides a computer program stored in a medium to execute steps of generating spinlock resources depending on data sharers, measuring spinlock time for each spinlock resource, and integrating at least two spinlock resources with short spinlock times.

As described above, according to this embodiment, it is possible to minimize waiting time due to communication between cores in a multi-core system. Further, according to this embodiment, it is possible to optimize a resource through a dynamic spinlock.

### BRIEF DESCRIPTION OF THE DRAWINGS

In order that the disclosure may be well understood, there are now described various forms thereof, given by way of example, reference being made to the accompanying drawings, in which:

FIG. 1 is a diagram illustrating the process of acquiring and releasing a spinlock resource in a general multi-core system;

FIG. 2 is a diagram illustrating the process of acquiring and releasing a spinlock resource in a multi-core system according to an embodiment;

FIG. 3 is a configuration diagram of a device according to an embodiment;

FIG. 4 is a diagram showing the generation of a spinlock resource by RTE depending on the data sharing cases of applications according to an embodiment;

FIG. 5 is a flowchart showing a resource optimization method through a dynamic spinlock according to an embodiment; and

FIG. 6 is a flowchart showing a method of integrating spinlock resources by RTE according to an embodiment.

### DETAILED DESCRIPTION

Hereinafter, embodiments of the present disclosure are described in detail with reference to the accompanying drawings. It should be noted that the same reference numerals are used throughout the drawings to designate the same or similar components. Further, when it is determined that the detailed description of the known art related to the present disclosure may obscure the gist of the present disclosure, the detailed description will be omitted.

When describing components of the present disclosure, terms such as first, second, A, B, (a), or (b) may be used. The terms are for the purpose of distinguishing one component from another component and are not intended to limit the nature, order, or sequence of the components. It will be understood that when a component is referred to as being “coupled” or “connected” to another component, it can be directly coupled or connected to the other component or intervening elements may be present therebetween.

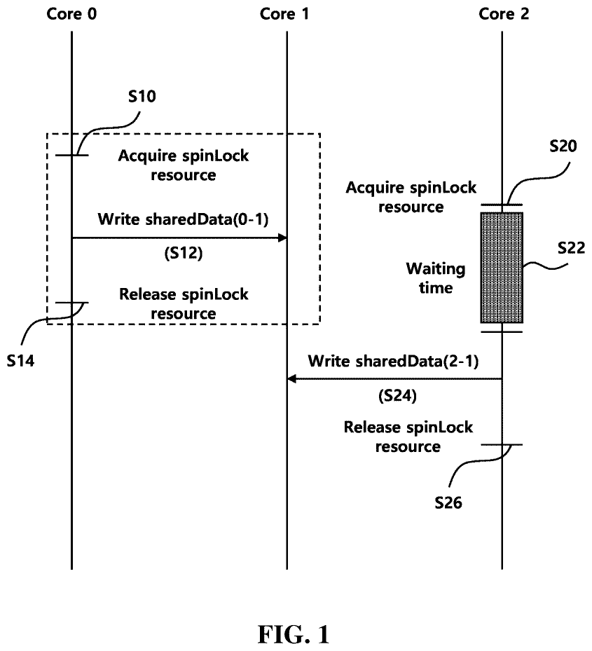

FIG. 1 is a diagram illustrating the process of acquiring and releasing a spinlock resource in a general multi-core system.

Referring to FIG. 1, when one core acquires the spinlock resource in a multi-core system including three or more cores, other cores wait for a significant amount of time, which may lead to a problem in real-time performance.

For example, when a first core Core 0 acquires the spinlock resource first in S10, the first core Core 0 should wait in S22 until the first core releases the spinlock resource in S14 even if a third core Core 2 requests to acquire the spinlock resource in S20.

In the example of FIG. 1, the first core Core 0 may acquire the spinlock resource in S10. After acquiring the spinlock resource, the first core Core 0 may write data to a shared memory (0-1) for data communication between the first core Core 0 and the second core Core 1 in S12. Further, the first core Core 0 may release the spinlock resource in S14.

When the first core Core 0 has acquired the spinlock resource, the third core Core 2 may request to acquire the spinlock resource in S20. At this time, since the spinlock resource is not acquired immediately, the third core Core 2 should wait until it acquires the spinlock resource in S22. After the first core Core 0 releases the spinlock resource in S14, the third core Core 2 may substantially acquire the spinlock resource. Further, the third core Core 2 may write data to a shared memory (2-1) for data communication between the third core Core 2 and the second core Core 1 in S24. Further, the third core Core 2 may release the spinlock resource in S26.

According to the example of FIG. 1, the real-time performance of the system may be impaired because the third core Core 2 should wait for a significant amount of time in S22.

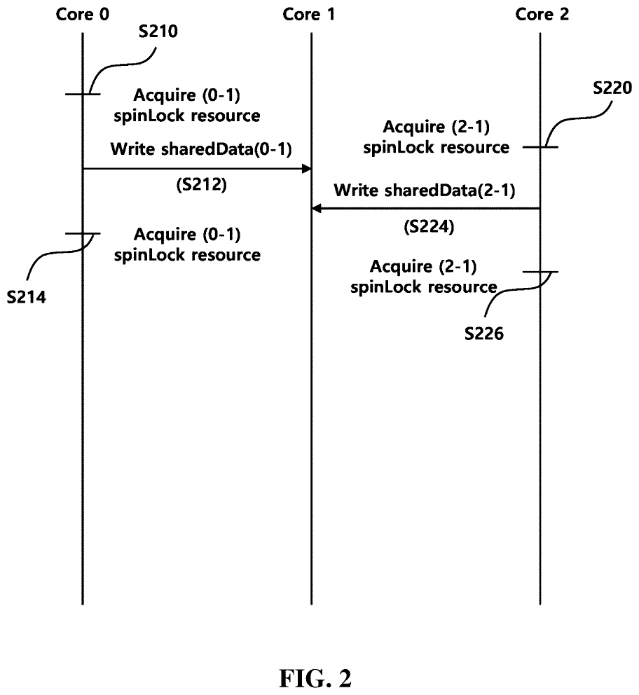

FIG. 2 is a diagram illustrating the process of acquiring and releasing a spinlock resource in a multi-core system according to an embodiment.

Referring to FIG. 2, the first core Core 0 may acquire the spinlock resource (0-1) for data communication between the first core Core 0 and the second core Core 1 in S210. Further, the first core Core 0 may write data to the shared memory (0-1) for data communication between the first core Core 0 and the second core Core 1 in S212.

Meanwhile, before the first core Core 0 releases the spinlock resource (0-1), the third core Core 2 may acquire the spinlock resource (2-1) for data communication between the third core Core 2 and the second core Core 1 in S220.

Here, the multi-core system according to an embodiment has different spinlock resources depending on data sharers, so that each core may acquire the spinlock resource without a waiting time. For example, even after the first core Core 0 acquires the spinlock resource (0-1), the third core Core 2 may acquire a different spinlock resource (2-1).

After the third core Core 2 acquires the spinlock resource (2-1), data may be written to the shared memory (2-1) for data communication between the third core Core 2 and the second core Core 1 in S224.

Further, the first core Core 0 may release the spinlock resource (0-1) after a data operation is completed in S214, and the third core Core 2 may release the spinlock resource (2-1) after the data operation is completed.

The multi-core system according to an embodiment can minimize waiting time and secure the real-time performance of the system by generating the spinlock resources depending on data sharers.

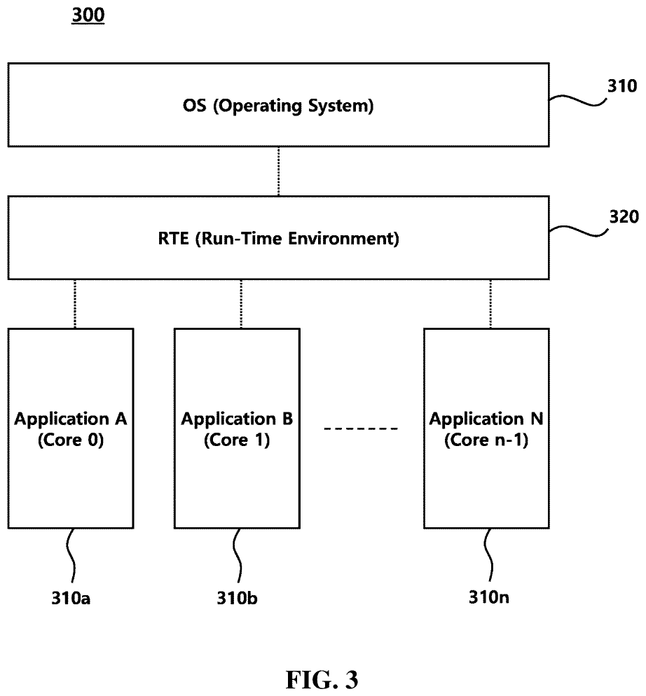

FIG. 3 is a configuration diagram of a device according to an embodiment.

Referring to FIG. 3, the device 300 may include an Operating System (OS) 310 and Run-Time Environment (RTE) 320. The device 300 may include a plurality of applications 310a, 310b, . . . , 310n running on the different cores.

The OS 310 may be a Real-Time Operating System (RTOS). The OS 310 may manage a task and an interrupt (ISR), and may handle the priority, scheduling, communication, and synchronization of the take and interrupt.

The RTE 320 may be a layer that provides an interface between software components. Further, the RTE 320 may act as an intermediary to enhance the reusability and portability of the software components. Components defined according to AUTOSAR methodology may communicate through the RTE 320 instead of directly accessing actual hardware or other components. The RTE 320 may relay data and control flow between these components, and may handle a service call, an event, a data request, etc.

The RTE 320 may support data sharing between the applications. The RTE 320 may provide an Inter-Core Communication (ICC) mechanism to support data exchange between the applications when the applications are executed on the different cores.

The RTE 320 may provide a data mapping mechanism to effectively map and transmit data between the cores. This may especially play an important role in exchanging data between the applications executed on the different cores. Further, the service call or event between the applications may be transferred to other cores through the RTE 320. This allows for easy interaction and communication between the cores. In the multi-core system as in the embodiment, task distribution and optimization may be important topics, and the RTE 320 may provide a mechanism to allocate tasks to appropriate cores and improve the overall performance of the system.

Meanwhile, data that may be accessed simultaneously from different cores may face synchronization and consistency problems. To solve these problems, the RTE 320 may use a spinlock technique.

The RTE 320 according to an embodiment may generate spinlock resources depending on the data sharing cases of the applications so as to minimize waiting time due to the spinlock.

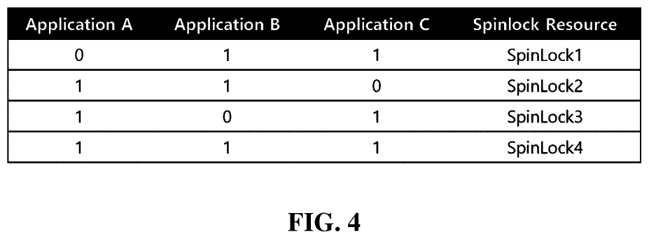

FIG. 4 is a diagram showing the generation of a spinlock resource by RTE depending on the data sharing cases of applications according to an embodiment.

Referring to FIG. 4, the RTE may generate the spinlock resource depending on the data sharing cases of the applications.

For example, the RTE may generate a first spinlock resource (SpinLock1) for a case where the application B and the application C share data, may generate a second spinlock resource (SpinLock2) for a case where the application A and the application B share data, may generate a third spinlock resource (SpinLock3) for a case where the application A and the application C share data, and may generate a fourth spinlock resource (SpinLock4) for a case where the application A, the application B, and the application C share data.

The spinlock resource may include an identifier, and the RTE may generate the identifier by allocating one bit of the identifier to each sharer of the data. In another aspect, the RTE may manage data sharing between the applications as pair information, which may be expressed as a bit value.

For example, the identifier of the first spinlock resource (SpinLock1) for the case where the application B and the application C share data may have the value of 011b, the identifier of the second spinlock resource (SpinLock2) for the case where the application A and the application B share data may have the value of 110b, the identifier of the third spinlock resource (SpinLock3) for the case where the application A and the application C share data may have the value of 101b, and the identifier of the fourth spinlock resource (SpinLock4) for the case where the application A, the application B, and the application C share data may have the value of 111b.

These spinlock resources may be stored and managed in a Random Access Memory (RAM). In the prior art, the spinlock resource is stored in a Read Only Memory (ROM), whereas in an embodiment, the spinlock resources are stored in the RAM, thereby enabling an easy change and efficient resource management.

If multiple spinlock resources are generated, the aforementioned waiting time problem may be minimized. However, in this case, there may be difficulties in management as the spinlock resources increase. The RTE according to an embodiment may generate the spinlock resources depending on the data sharing cases of the applications, and may integrate at least two spinlock resources with short spinlock times after measuring the spinlock time for each spinlock resource, thereby preventing the spinlock resources from being excessively used. This technique may be called a resource optimization method through a dynamic spinlock.

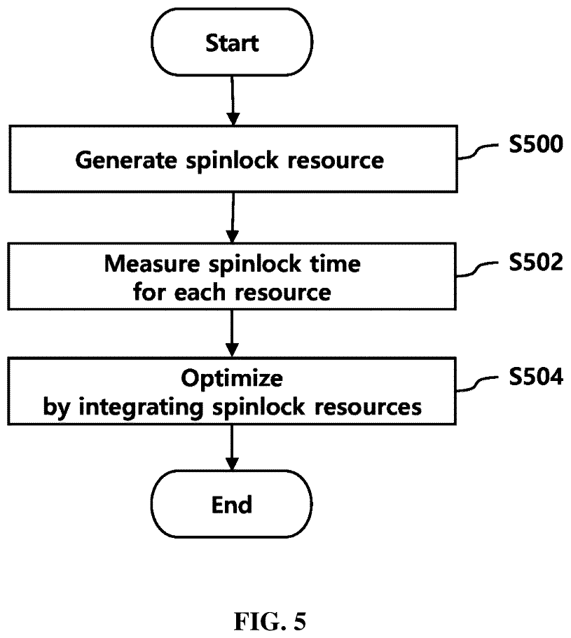

FIG. 5 is a flowchart showing a resource optimization method through a dynamic spinlock according to an embodiment.

Referring to FIG. 5, the RTE may generate spinlock resources depending on the sharers of data in S500.

The RTE may store information about a sender and a receiver that share data. This information may be stored during the configuration and design stage of the system.

Further, the RTE may generate the spinlock resources depending on the data sharers. For example, the RTE may generate the spinlock resources for all cases of the data sharers. The RTE may allocate one bit for each data sharer, and generate the identifier for each spinlock resource using the value of a corresponding bit. The RTE may independently allocate each spinlock resource according to the data sharing case. At this time, the data sharing case may be 1:1 or 1:N (Nis a natural number of 2 or more).

The RTE may store the generated spinlock resources in the RAM.

The microcontroller may include several types of memories.

The ROM is a memory that permanently stores data, and may preserve data even after power is turned off. According to an embodiment of the microcontroller, a fixed program such as firmware or bootloading code may be stored in the ROM.

A flash memory is a non-volatile memory that may be electrically reprogrammed. A data block larger than an Electrically Erasable Programmable Read-Only Memory (EEPROM) may be quickly deleted and recorded. A recent microcontroller may use the flash memory to store a program code and data.

While data contained in the flash memory may be deleted and recorded, the number of times is limited, and the size of the data block that may be deleted or recorded at one time is large, so it may not be appropriate to store data requiring a change in the flash memory.

The RTE may store spinlock resources generated for ease of management in the RAM. The RAM is a volatile memory, so stored data is lost when power is turned off. The RAM may be used for an operation in the microcontroller and for storing data for a running program, and the RTE may store and manage the spinlock resources in the RAM to use these properties of the RAM.

The RTE may measure spinlock time for each spinlock resource in S502.

Each application may call a function to acquire the spinlock resource for data sharing. For example, each application may call a function such as ‘GetSpinlock’. The RTE may recognize a call to the function and record time when each application calls the function.

The function may include the identifier of the spinlock resource as an argument. The RTE may then use the identifier transmitted as the argument to determine which application is attempting to acquire the spinlock resource for data sharing with any application.

For example, in an embodiment, the identifier is allocated one bit for each data sharer. The RTE may look at the identifier and recognize the data sharers. When the identifier is 011b, the RTE may recognize that the second application and the third application request the spinlock resource to share data.

Each application may share data after acquiring the spinlock resource. Further, each application may release the spinlock resource after sharing data.

For example, each application may call a function such as ‘ReleaseSpinlock’. The RTE may recognize the call of the function and record time when each application calls the function that releases the spinlock resource.

The function may include the identifier of the spinlock resource as an argument. Then, the RTE may use the identifier transmitted to the argument to determine which application releases the spinlock resource for data sharing with any application.

For example, in an embodiment, the identifier is allocated one bit for each data sharer. The RTE may look at the identifier and recognize the data sharers. When the identifier is 011b, the RTE may recognize that the second application and the third application release the spinlock resource used to share data.

The RTE may measure the spinlock time for each spinlock resource using a difference between time when the function for acquiring the spinlock resource is called and time when the function for releasing the spinlock resource is called.

The RTE may run on an Automotive Open System Architecture (AUTOSAR) OS, and the spinlock time may be measured at runtime when the system runs. The AUTOSAR OS may include a high resolution timer. The timer is also called “Stochastic Distribution Timer (SDT)” or “High Resolution Timer (HRT)”. The RTE may measure the spinlock time at runtime using the high resolution timer

The RTE may measure spinlock time for each spinlock resource multiple times, and store a statistical representative value. The representative value may be, for example, an average value, a median value, or a mode.

The RTE may obtain the average value by dividing the sum of the spinlock times measured for each spinlock resource by a number. Alternatively, the RTE may use a moving average method to continuously and cumulatively obtain the average value of the spinlock times measured for each spinlock resource.

If the RTE may sort the spinlock times for each spinlock resource, a value located in the middle may be obtained as the median value.

In addition, according to an embodiment, the RTE may select a maximum value or a minimum value as the representative value.

After the spinlock time for each spinlock resource is measured, the RTE may optimize the resource by integrating at least two spinlock resources with short spinlock times in S504.

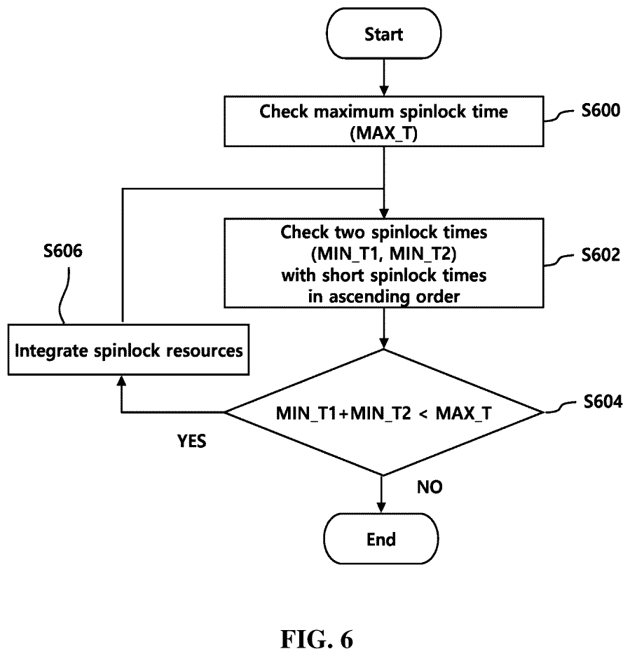

FIG. 6 is a flowchart showing a method of integrating spinlock resources by RTE according to an embodiment.

Referring to FIG. 6, the RTE may check a maximum spinlock time MAX_T among a plurality of spinlock times in S600.

The RTE may sort a plurality of spinlock times. For example, the RTE may sort the plurality of spinlock times by comparing two adjacent times and swapping positions when necessary, according to a bubble sort technique. As another example, the RTE may select a pivot element using a quick sort technique, divide data into two parts based on the selected element, and then recursively sort each part.

The RTE may check the maximum spinlock time MAX_T on the sorted data. The RTE may check two spinlock times MIN_T1 and MIN_T2 in ascending order from among the plurality of spinlock times.

The RTE may calculate the sum of the first shortest time MIN_T1 and the second shortest time MIN_T2 for the spinlock time, and compare the sum with the maximum spinlock time MAX Tin S604.

Further, the RTE may continue to integrate at least two spinlock resources with short spinlock times until the sum of the first shortest time MIN_T1 and the second shortest time MIN_T2 becomes longer than the maximum spinlock time MAX Tin S606.

For example, when the sum of the first shortest time MIN_T1 and the second shortest time MIN_T2 is less than the maximum spinlock time MAX_T (YES in S604), the RTE may integrate the spinlock resources corresponding to the first shortest time MIN_T1 and the second shortest time MIN_T2 in S606.

The RTE may make the identifiers of the spinlock resources to be integrated identical. For example, the RTE may cause the identifier of the spinlock resource with the first shortest time MIN_T1 to be identical to the identifier of the spinlock resource with the second shortest time MIN_T2. In this way, the spinlock resource with the first shortest time MIN_T1 may be excluded from management.

Meanwhile, the above-described method may be executed by hardware such as the microcontroller. Here, the hardware does not mean just a single microcontroller, but may also mean a multi-core system. Each step of the above-described method may be distributed and executed across a plurality of microcontrollers, or may be executed on a single microcontroller.

The AUTOSAR OS supports multi-core environment. Each core may run its own instance of the OS. This means that each core may execute an independent set of tasks or collaborate with other cores to perform tasks. In the multi-core system described above, the OS may run on one core and/or one microcontroller, or may be cooperatively run on the plurality of cores.

The RTE may operate in a distributed manner across each core. In the OS environment that supports the multi-core environment, the RTE may be distributed and operated across each of the cores that perform tasks independently or cooperatively. Each core has its own RTE instance, which enables communication and interaction between the application running on a corresponding core and the application on another core.

The application running on each core may access various services and functions through the RTE. For example, data exchange between the applications may be performed through the RTE. The application may read or write data using the Application Programming Interface (API) of the RTE, for example, by calling the APIs such as ‘Rte_Read’ or ‘Rte_Write’.

The RTE may call a function within the application according to a specific event or condition. For example, a specific function of the application may be executed in response to an event such as a data change, timer expiration, or interrupt occurrence.

The RTE may manage the execution and synchronization of the application. For example, when a specific application requests a service from another application, the RTE may synchronize the request and the response, and schedule the execution of other applications as needed.

The above-described method, the configuration of the above-described device, etc. can be implemented and operated on such hardware and/or software basis.

As described above, according to this embodiment, it is possible to minimize waiting time due to communication between cores in a multi-core system. Further, according to this embodiment, it is possible to optimize a resource through a dynamic spinlock.

It will be understood that the terms “comprise”, “include”, “have”, etc., when used in this specification, specify the presence of stated components but do not preclude the presence or addition of one or more other components, unless the context clearly indicates otherwise. Unless otherwise defined, all terms including technical and scientific terms used herein have the same meaning as commonly understood by one of ordinary skill in the art to which the present disclosure belongs. It will be further understood that terms used herein should be interpreted as having a meaning that is consistent with their meaning in the context of this specification and the relevant art and will not be interpreted in an idealized or overly formal sense unless expressly so defined herein.

The above description is merely an example of the technical idea of the present disclosure, and those skilled in the art will appreciate that various modifications and changes may be made without departing from the essential characteristics of the present disclosure. Thus, the embodiments disclosed in the present disclosure are not intended to limit the technical idea of the present disclosure but to explain it, and the scope of the technical idea of the present disclosure is not limited by the embodiment. The protection scope of the present disclosure should be interpreted by the claims below, and all technical ideas within a scope equivalent thereto should be interpreted as being included in the scope of the rights of the present disclosure.

What is claimed is:

1. A resource optimization method using a dynamic spinlock, the method comprising:
generating a plurality of spinlock resources depending on data sharers;
measuring a spinlock time for each spinlock resource among the plurality of spinlock resources; and
integrating at least two spinlock resources of the plurality of spinlock resources with short spinlock times.

2. The resource optimization method of claim 1, wherein the generating the plurality of spinlock resources comprises generating the plurality of spinlock resources which correspond with all cases of the data sharers.

3. The resource optimization method of claim 2, wherein one bit is allocated for each of the data sharers, and an identifier for the each spinlock resource is generated using a value of a corresponding bit.

4. The resource optimization method of claim 1, wherein identifiers of the at least two spinlock resources are made identical when the integrating the at least two spinlock resources is performed.

5. The resource optimization method of claim 4, wherein the identifiers are stored in a Random Access Memory (RAM).

6. The resource optimization method of claim 1, wherein the at least two spinlock resources having the short spinlock times are continuously integrated until a sum of the first shortest spinlock time and the second shortest spinlock time becomes longer than the longest spinlock time when the integrating the at least two spinlock resources is performed.

7. The resource optimization method of claim 1, wherein the data sharers operate on different cores of at least one microcontroller.

8. A resource optimization device using a dynamic spinlock, the device comprising:
a plurality of applications to run on different cores; and
a Runtime Environment (RTE) to support data sharing between the plurality of applications,
wherein the RTE generates a plurality of spinlock resources depending on data sharing cases of the plurality of applications, measures a spinlock time for each one of the plurality of spinlock resources, and then integrates at least two spinlock resources of the plurality of spinlock resources with short spinlock times.

9. The resource optimization device of claim 8, wherein the plurality of spinlock resources are stored and managed in a RAM.

10. The resource optimization device of claim 8, wherein:
the RTE manages data sharing between the plurality of applications as a pair information, and
wherein the pair information is expressed as a bit value.

11. The resource optimization device of claim 8, wherein the data sharing cases comprise a 1:1 sharing and a 1:N (N is a natural number of 2 or more) sharing.

12. The resource optimization device of claim 8, wherein the RTE runs on an Automotive Open System Architecture (AUTOSAR) OS.

13. The resource optimization device of claim 8, wherein the RTE independently allocates the each one of the plurality of spinlock resources depending on the data sharing cases.

14. The resource optimization device of claim 8, wherein the spinlock time is measured at runtime.

15. The resource optimization device of claim 8, wherein the RTE allocates one bit for each one of the plurality of applications, and the RTE generates an identifier for the each one of the plurality of spinlock resources based on a value of a corresponding bit.

16. The resource optimization device of claim 15, wherein the RTE makes identifiers for the plurality of spinlock resources to be integrated identically.

17. The resource optimization device of claim 16, wherein the identifiers are stored in a RAM variable.

18. A non-transitory computer-readable medium, comprising a set of instructions stored thereon, that when executed by a processor, perform steps of:
generating a plurality of spinlock resources depending on data sharers;
measuring a spinlock time for each spinlock resource among the plurality of spinlock resources; and
integrating at least two spinlock resources of the plurality of spinlock resources with short spinlock times.
